(19) United States
(12) Patent Application Publication
(10) Pub. No.: US 2017/0322709 A1
(43) Pub. Date: Nov. 9, 2017

(54) SPLIT-SCREEN DISPLAY METHOD, APPARATUS AND MEDIUM

(71) Applicant: Beijing Xiaomi Mobile Software Co., Ltd., Haidian District (CN)

(72) Inventors: Qiaozhuo CHEN, Beijing (CN); Zhenzhou LU, Beijing (CN); Yin ZHU, Beijing (CN)

(21) Appl. No.: 15/586,299

(22) Filed: May 4, 2017

(30) Foreign Application Priority Data
May 9, 2016 (CN) 201610304861.8

(51) Int. Cl. G06F 3/0484

(52) U.S. Cl. CPC G06F 3/04845; G06F 2203/04803

(57) ABSTRACT

A split-screen display method, apparatus and medium are provided. The split-screen display method includes: receiving an operating signal for triggering display of a multi-task management interface, the multi-task management interface including a main partition and a secondary partition; acquiring a plurality of applications running on the electronic device, the plurality of applications including a first application and at least one second application; and displaying the first application on the main partition and displaying the at least one second application on the secondary partition.

### CROSS REFERENCE TO RELATED APPLICATION

This application is based upon and claims a priority to Chinese Patent Application Serial No. 201610304861.8, filed with the State Intellectual Property Office of P. R. China on May 9, 2016, the entire contents of which are incorporated herein by reference.

### TECHNICAL FIELD

The present disclosure relates to the field of electronic devices, and more particularly, to a split-screen display method, apparatus and medium.

### BACKGROUND

An electronic device configured with an intelligent operating system may support only one application running in foreground, which means that only one application in a running state may be displayed on a screen of the electronic device.

A user may only switch the application running in foreground repeatedly when two applications are needed in the same time. For example, the user may need to use application A running in foreground and application B running in background at the same time. The user needs to switch the application A to run in background and then to switch the application B to run in foreground when the application B is needed to be viewed; and the user needs to switch the application A to run in foreground again when the application A is needed to be viewed.

### SUMMARY

The present disclosure provides a split-screen display method, apparatus and medium.

According to a first aspect of embodiments of the present disclosure, a split-screen display method applied to an electronic device is provided. The method includes: receiving an operating signal for triggering display of a multi-task management interface, the multi-task management interface comprising a main partition and a secondary partition; acquiring a plurality of applications running on the electronic device, the plurality of applications comprising a first application and at least one second application; and displaying the first application on the main partition and displaying the at least one second application on the secondary partition.

According to a second aspect of embodiments of the present disclosure, a split-screen display apparatus applied to an electronic device is provided. The apparatus includes: a processor; and a memory configured to store an instruction executable by the processor, in which the processor is configured to: receive an operating signal for triggering display of a multi-task management interface, the multi-task management interface comprising a main partition and a secondary partition; acquire a plurality of applications running on the electronic device, the plurality of applications comprising a first application and at least one second application; and display the first application on the main partition and displaying the at least one second application on the secondary partition.

According to a second aspect of embodiments of the present disclosure, a non-transitory computer readable storage medium having stored therein instructions that, when executed by a processor, causes the processor to perform a split-screen display method, and the method includes: receiving an operating signal for triggering display of a multi-task management interface, the multi-task management interface comprising a main partition and a secondary partition; acquiring a plurality of applications running on the electronic device, the plurality of applications comprising a first application and at least one second application; and displaying the first application on the main partition and displaying the at least one second application on the secondary partition.

It is to be understood that both the foregoing general description and the following detailed description are exemplary and explanatory only and are not restrictive of the present disclosure.

### BRIEF DESCRIPTION OF THE DRAWINGS

Accompanying drawings herein are incorporated in and constitute a part of the specification, and illustrate example embodiments in line with the present disclosure, and serve to explain the principle of the present disclosure together with the description.

FIG. 1 is a flow chart illustrating a split-screen display method according to an example embodiment of the present disclosure;

FIG. 2A is a flow chart illustrating a split-screen display method according to another example embodiment of the present disclosure;

FIG. 2B is a schematic diagram illustrating a display of a triggered multi-task management interface according to an example embodiment of the present disclosure;

FIG. 2C is a schematic diagram illustrating a multi-task management interface according to an example embodiment of the present disclosure;

FIG. 2D is a schematic diagram illustrating a multi-task management interface including a main partition and a secondary partition according to an example embodiment of the present disclosure;

FIG. 2E is a schematic diagram illustrating a multi-task management interface in a split-screen mode according to an example embodiment of the present disclosure;

FIG. 2F is a schematic diagram illustrating a sceniario of displaying an application corresponding to a previewing interface displayed on a secondary partition and selected on the secondary partition according to an example embodiment of the present disclosure;

FIG. 2G is a flow chart illustrating a method for displaying on a main partition a third application selected from a secondary partition instead of a first application according to an example embodiment of the present disclosure;

FIG. 2H is a schematic diagram illustrating a sceniario where a first application is replaced with a third application selected from a secondary partition so as to display the third application on a main partition;

FIG. 2I is a schematic diagram illustrating a sceniario of displaying a multifunctional virtual button on a secondary partition according to an example embodiment of the present disclosure;

FIG. 3 is a block diagram illustrating a split-screen display apparatus according to an example embodiment of the present disclosure;

FIG. 4 is a block diagram illustrating a split-screen display apparatus according to another example embodiment of the present disclosure; and

FIG. 5 is a block diagram illustrating a split-screen display device according to an example embodiment of the present disclosure.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of apparatuses and methods consistent with aspects related to the invention as recited in the appended claims.

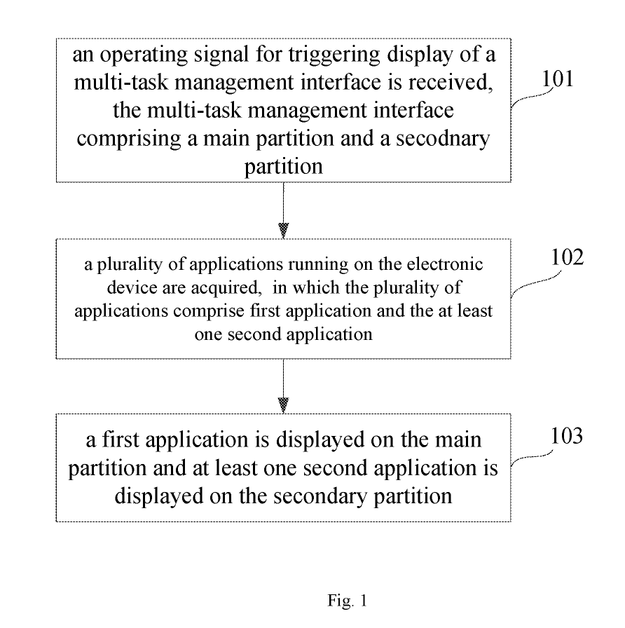

FIG. 1 is a flow chart illustrating a split-screen display method according to an example embodiment of the present disclosure. The split-screen display method is applied to an electronic device including a touch screen and may include followings.

In act 101, an operating signal for triggering display of a multi-task management interface is received, and the multi-task management interface includes a main partition and a secondary partition.

In act 102, a plurality of applications running on the electronic device are acquired, and the plurality of applications include a first application and at least one second application.

In act 103, the first application is displayed on the main partition and the at least one second application is displayed on the secondary partition.

In conclusion, according to the split-screen display method provided by embodiments of the present disclosure, by receiving the operating signal for triggering display of the multi-task management interface, displaying the first application on the main partition of the multi-task management interface and displaying the at least one second application on the secondary partition of the multi-task management interface, in which the first application and the at least one second application are running on the electronic device, i.e., by splitting the multi-task management interface into the main partition and the secondary partition for displaying different applications, a user may be able to use at least two applications at the same time, which may avoid that means for displaying the application on the electronic device provided are quite simple and may improve the user's experience as well.

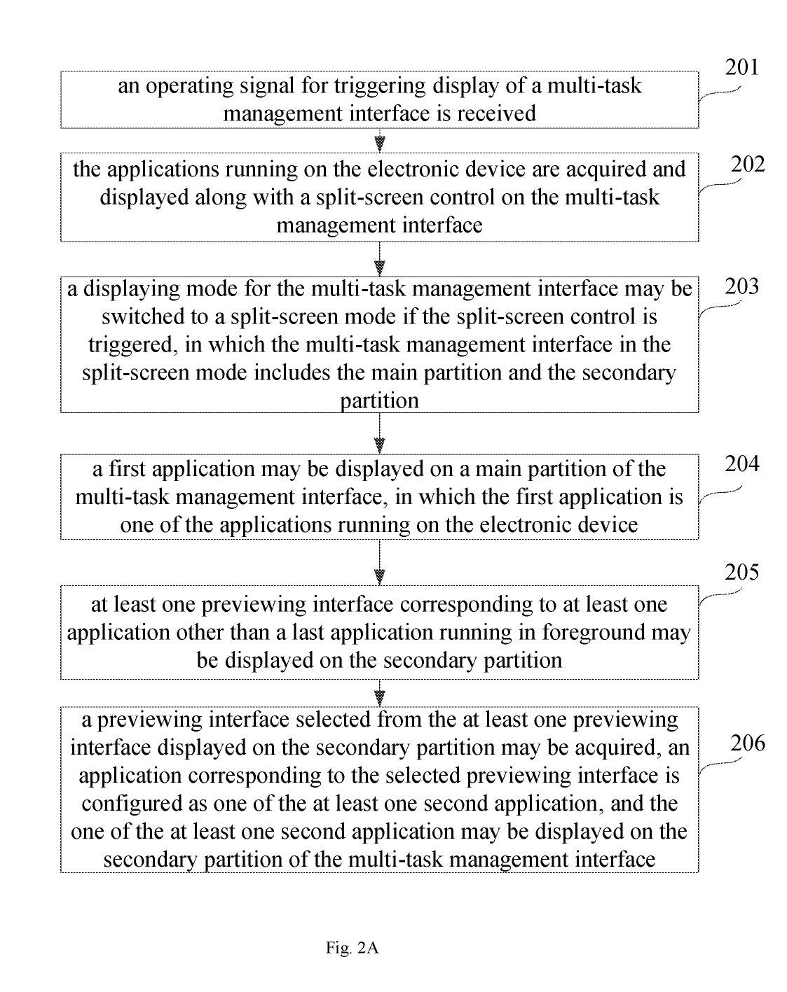

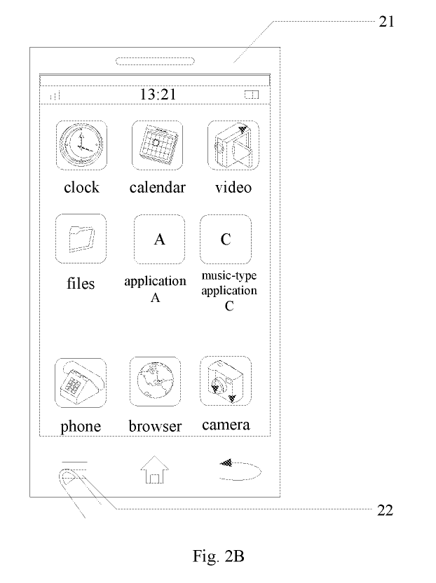

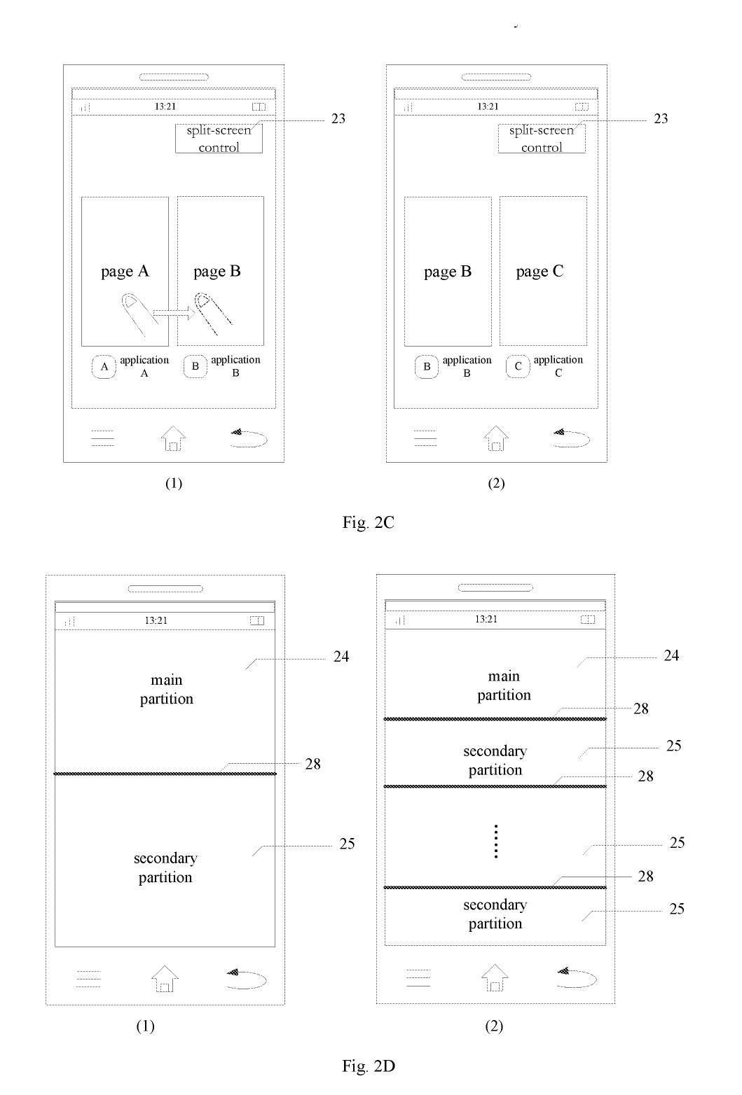

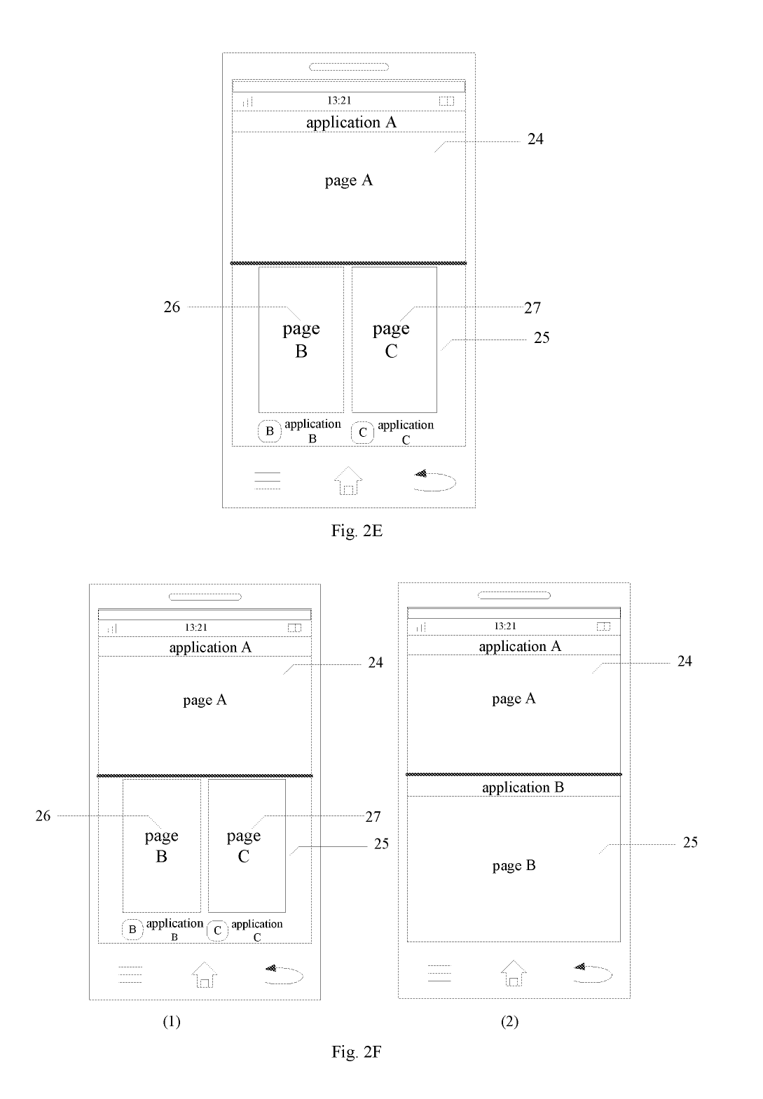

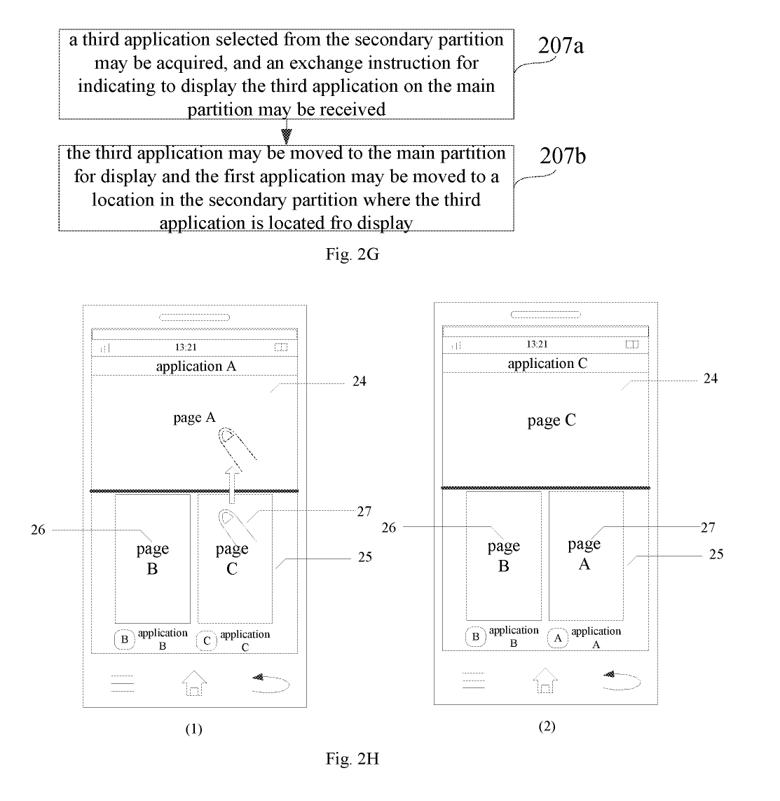

FIG. 2A is a flow chart illustrating a split-screen display method according to another example embodiment of the present disclosure. The split-screen display method is applied to an electronic device including a touch screen and may include followings.

In act 201, an operating signal for triggering display of a multi-task management interface is received.

The operating signal described herein may be generated when a certain physical button on an electronic device is triggered, or may be a gesture input by the user on the touch screen of the electronic device, or may be generated when the electronic device is shaken following a preset track. The operating signal may be not limited in the embodiments of the present disclosure and may be determined depending on actual situations.

This embodiment takes a scenario in which a certain physical button on an electronic device is triggered to generate the operating signal as an example for illustrating. As shown in FIG. 2B, a multi-task button 22 is provided on the electronic device 21, in which the multi-task button 22 is configured to trigger display of the multi-task management interface. The electronic device may receive the operating signal for triggering display of the multi-task management interface when the user clicks the multi-task button 22.

Generally, the multi-task management interface is configured to display applications running on the electronic device, and each of the applications displayed on the multi-task management interface may be displayed in a form of a previewing interface corresponding to the application. The previewing interface described herein may be a last interface of the application displayed on a screen of the electronic device before the application stops running in foreground. Alternatively, the previewing interface of the application may be a main interface corresponding to the application.

In act 202, a plurality of applications running on the electronic device are acquired and displayed along with a split-screen control on the multi-task management interface.

Each of the plurality of applications may be displayed in the form of the previewing interface corresponding to the application when the applications running on the electronic device are displayed on the multi-task management interface.

Specifically, various arrangement modes may be adopted when previewing interfaces corresponding respectively to the applications are displayed. For example, the previewing interfaces corresponding respectively to the applications may be arranged horizontally in a single row according to a first preset order. For another example, the previewing interfaces corresponding respectively to the applications may be arranged horizontally in double rows according to the first preset order. The first preset order described herein may be an order of opening the applications recently, or may be an order of frequencies of using the applications, which may be determined depending on actual situations and may be not limited in the embodiments of the present disclosure.

The split-screen control may be displayed on any location within the multi-task management interface. This embodiment takes a scenario in which the split-screen control is set at the top right corner of the multi-task management interface as an example for illustrating. As shown in FIG. 2C (1), the split-screen control is displayed at the top right corner of the multi-task management interface.

Generally, only a finite number of the previewing interfaces may be displayed on the screen of the electronic device. The user may input a preset gesture to trigger more previewing interfaces corresponding respectively to the applications running on the electronic device to display if more previewing interfaces corresponding respectively to the applications running on the electronic device are needed to be viewed. For example, the applications running on the electronic device include application A, application B and application C. as shown in FIG. 2C (1), the previewing interfaces corresponding to the applications are arranged horizontally in a single row. Due to a limitation of the screen's size, application C may be not displayed on the screen. The user may input a right-slide gesture for triggering display of the previewing interface corresponding to the application C, as shown in FIG. 2C (2).

In act 203, a displaying mode for the multi-task management interface may be switched to a split-screen mode if the split-screen control is triggered, in which the multi-task management interface in the split-screen mode includes the main partition and the secondary partition.

Generally, the applications running on the electronic device and the split-screen control are displayed on the multi-task management interface, and the displaying mode for the multi-task management interface may be switched to the split-screen mode if the split-screen control is triggered, and the multi-task management interface is split into the main partition and the secondary partition.

It should be noted that the multi-task management interface in the split-screen mode includes only one main partition, but may include one or more secondary partitions. This embodiment takes a scenario in which the multi-task management interface includes only one main partition and one secondary partition as an example for illustrating. Implementations of the scenario in which the multi-task management interface includes one main partition and several secondary partitions may be realized in accordance with means provided by this embodiment.

As shown in FIG. 2D (1), a schematic diagram is provided for illustrating a multi-task management interface including one main partition 24 and one secondary partition 25. As shown in FIG. 2D (2), a schematic diagram is provided for illustrating a multi-task management interface including one main partition 24 and at least two secondary partitions 25.

In act 204, a first application may be displayed on a main partition of the multi-task management interface, in which the first application is one of the applications running on the electronic device.

The main partition may be set in any region of the multi-task management interface. Generally, the main partition may be set in a location of the multi-task management interface near a top of the screen. For example, referring to FIG. 2D (1) again, the main partition 23 of the multi-task management interface is shown at the top of the screen.

Specifically, displaying the first application on the main partition of the multi-task management interface may be realized by followings: acquiring a last application running in foreground as the first application, and displaying the first application on the main partition of the multi-task management interface.

For example, when there is application A running in foreground of the electronic device, the user may trigger the multi-task button on the electronic device to trigger display of the multi-task management interface, and click the split-screen control provided in the multi-task management interface such that the displaying mode for the multi-task management interface is switched to the split-screen mode. As shown in FIG. 2E, application A is treated as the first application and thus is displayed on the main partition 24 of the multi-task management interface. Page A exhibited by application A may be a last interface of the application A displayed on the screen of the electronic device before the application A stops running in foreground, or may be a main interface corresponding to the application A.

For example, when there is no application running in foreground of the electronic device, the user may trigger the multi-task button on the electronic device to display of the multi-task management interface, and click the split-screen control provided in the multi-task management interface such that the displaying mode for the multi-task management interface is switched to the split-screen mode. As shown in FIG. 2E, application A running on the electronic device lately is treated as the first application and thus is displayed on the main partition 24 of the multi-task management interface. Page A exhibited by application A may be a last interface of the application A displayed on the screen of the electronic device before the application A stops running in foreground, or may be a main interface corresponding to the application A.

In act 205, at least one previewing interface corresponding to at least one application other than a last application running in foreground may be displayed on the secondary partition.

Various arrangement modes may be adopted when previewing interfaces corresponding respectively to the applications are displayed. For example, the previewing interfaces corresponding respectively to the applications may be arranged horizontally in a single row according to a second preset order. For another example, the previewing interfaces corresponding respectively to the applications may be arranged horizontally in double rows according to the second preset order. The second order described herein may be an order of opening the applications recently, or may be an order of frequencies of using the applications, which may be determined depending on actual situations and may be not limited in the embodiments of the present disclosure.

For example, as shown in FIG. 2E, the last application running in foreground may be application A, and the applications running on the electronic device may also include application B and application C except for application A. The previewing interface 26 corresponding to application B and the previewing interface 27 corresponding to application C may be displayed on the secondary partition 25.

Generally, only a finite number of the previewing interfaces may be displayed on the secondary partition. The user may input a preset gesture to trigger more previewing interfaces corresponding respectively to the applications running on the electronic device to exhibit if the user wants to view more previewing interfaces corresponding respectively to the applications running on the electronic device in the secondary partition.

In act 206, a previewing interface selected from the at least one previewing interface displayed on the secondary partition may be acquired, an application corresponding to the selected previewing interface is configured as one of the at least one second application, and the one of the at least one second application may be displayed on the secondary partition of the multi-task management interface.

For example, as shown in FIG. 2F (1), page B i.e., the previewing interface 26 corresponding to application B and page C i.e., the previewing interface 27 corresponding to application C may be displayed on the secondary partition 25. The user may click page B i.e., previewing interface 26 corresponding to application B. As shown in FIG. 2F (2), application B corresponding to the previewing interface 26 may be treated as the second application and may be displayed on the secondary partition 25 of the multi-task management interface, and page B i.e., previewing interface may be exhibited in application B.

It should be noted that the first application displayed on the main partition is running in foreground and may be operated by the user; the second application displayed on the secondary partition is also running in foreground and may also be operated by the user. In other words, the first application displayed on the main partition and the second application displayed on the secondary partition are both running in foreground and the user may operate any application displayed on any one of the main partition and the secondary partition. For example, the user may play games by using a game application displayed on the main partition and may chat with others by using a messaging application displayed on the secondary partition.

In conclusion, according to the split-screen display method provided by embodiments of the present disclosure, by receiving the operating signal for triggering display of the multi-task management interface, displaying the first application on the main partition of the multi-task management interface and displaying the at least one second application on the secondary partition of the multi-task management interface, in which the first application and the at least one second application are running on the electronic device, i.e., by splitting the multi-task management interface into the main partition and the secondary partition for displaying different applications, a user may be able to use at least two applications at the same time, which may diversify means for displaying the application on the electronic device and may improve the user's experience as well.

Additionally, by configuring the last application running in foreground as the first application in default and displaying the first application on the main partition, an operating procedure for acquiring the first application may be simplified and efficiency of split-screen display may be improved.

Additionally, the at least one previewing interface corresponding to at least one application other than a last application running in foreground may be displayed on the secondary partition for the user's selection, and the one of the at least one second application corresponding to the at least one previewing interface the user selects may be displayed on the secondary partition of the multi-task management interface.

Additionally, the multi-task management interface in the split-screen mode is set with a segment control line which is movable and is configured to split the multi-task management interface into the main partition and the secondary partition, such that the user may adjust sizes of the main partition and the secondary partition by moving the segment control line.

Alternatively, the user may select a third application from the secondary partition to replace the first application for displaying on the main partition when the first application is displayed on the main partition and at least one application other than a last application running in foreground is displayed on the secondary partition, which may be realized by several acts as shown in FIG. 2G

In act 207a, a third application selected from the secondary partition may be acquired, and an exchange instruction for indicating to display the third application on the main partition may be received.

Various means may be provided for the user to select the at least one application displayed on the secondary partition. For example, one of the at least one application may be selected as the third application by long pressing the previewing interface corresponding to the one of the at least one application, or by inputting a preset gesture on the previewing interface corresponding to the one of the at least one application. Generally, the exchange instruction described herein is the preset gesture the user inputs.

In act 207b, the third application may be moved to the main partition to display and the first application may be moved to a location in the secondary partition where the third application is located for display .

For example, as shown in FIG. 2H (1), the first application i.e., application A is displayed on the main partition 24, and the previewing interface 26 i.e., page B corresponding to application B running on the electronic device and the previewing interface 27 i.e., page C corresponding to application C may be displayed on the secondary partition. The user may select application C as the third application by long pressing the previewing interface 27 i.e., page C, and the user may input an up-slide gesture as the exchange instruction for instructing to display application C on the main partition. As shown in FIG. 2H (2), application C may be determined as the third application and may be moved to the main partition 24 to exhibit, and the first application i.e., application A may be moved to a location in the secondary partition 25 where the third application is located for display.

Alternatively, the multi-task management interface in the split-screen mode is set with a segment control line which is movable and is configured to split the multi-task management interface into the main partition and the secondary partition. Referring to FIG. 2D again, the multi-task management interface is set with the segment control line 28 which is movable, such that the user may adjust sizes of the main partition and the secondary partition by moving the segment control line 28.

Alternatively, the main partition or the secondary partition includes a multifunctional virtual button for introducing to display at least one of a split-screen exit control, an exchange control and a group of switching controls.

For example, as shown in FIG. 2I, the secondary partition 25 includes a multifunctional virtual button 29, such that at least one of the split-screen exit control, the exchange control and the group of the switching controls may be displayed if the multifunctional virtual button is triggered. The switching controls described herein may include a first switching control and a second switching control.

The multi-task management interface may be controlled to exit the split-screen mode if the split-screen exit control displayed is triggered. The multi-task management interface including the applications running on the electronic device and the split-screen control may be displayed normally and the first application displayed on the main partition may run (i.e., be displayed) in foreground after the multi-task management interface exits the split-screen mode, which may be not limited in this embodiment and may be determined depending on actual situations.

The main partition and the secondary partition may be controlled to exchange the applications displayed thereon if the exchange control exhibited is triggered. For example, application A may be displayed on the main partition and application B may be displayed on the secondary partition. Application A may be displayed on the secondary partition and application B may be displayed on the main partition if the exchange control is triggered.

The group of switching controls includes a first switching control for switching the application displayed on the main partition and a second switching control for switching the application displayed on the secondary partition, the application running on the electronic device other than the first application is displayed on the main partition if the first switching control is triggered; and the application running on the electronic device other than the second application is displayed on the secondary partition if the second switching control is triggered.

The application displayed on the main partition or the secondary partition may be switched to another application according to a preset order. The preset order may be an order of opening the applications recently, or may be an order of frequencies of using the applications, which may be determined depending on actual situations and may be not limited in the embodiments of the present disclosure.

It should be noted that this embodiment only takes a scenario that the multifunctional virtual button is provided on the secondary partition as an example. Implementation of a scenario that the multifunctional virtual button is provided on the main partition is similar to the implementation of a scenario that the multifunctional virtual button is provided on the secondary partition, which is not described herein.

Embodiments of the present disclosure also provide a split-screen display apparatus for implementing the split-screen display method as follows. Regarding details which are not disclosed in the embodiments of the split-screen display apparatus, reference may be made to the embodiments of the split-screen display method.

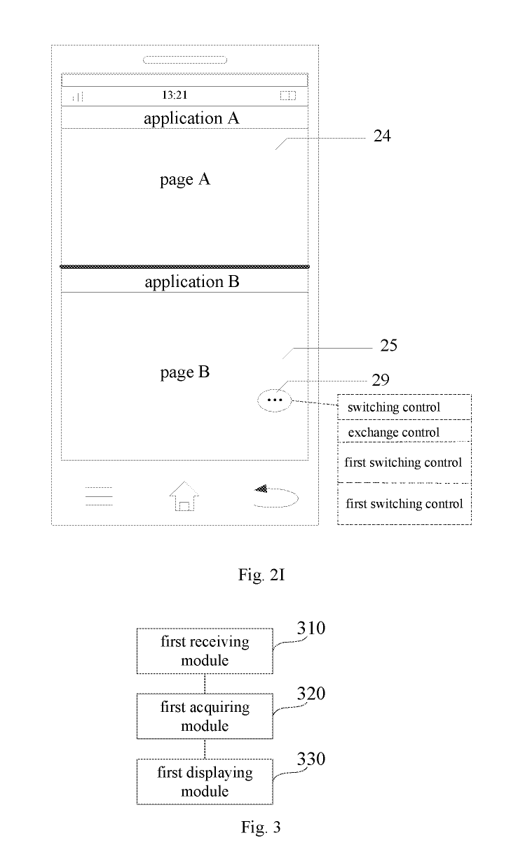

FIG. 3 is a block diagram illustrating a split-screen display apparatus according to an example embodiment of the present disclosure. The split-screen display apparatus is applied to an electronic device including a touch screen, which includes: a first receiving module 310, a first acquiring module 320 and a first displaying module 330.

The first receiving module 310 is configured to receive an operating signal for triggering display of a multi-task management interface. The multi-task management interface includes a main partition and secondary partition.

The first acquiring module 320 is configured to acquire a plurality of applications running on the electronic device. The plurality of applications include a first application and at least one second application.

The first displaying module 330 is configured to display the first application on the main partition and to display the at least one second application on the secondary partition.

In conclusion, according to the split-screen display apparatus provided by embodiments of the present disclosure, by receiving the operating signal for triggering display of the multi-task management interface, displaying the first application on the main partition of the multi-task management interface and displaying the at least one second application on the secondary partition of the multi-task management interface, in which the first application and the at least one second application are running on the electronic device, i.e., by splitting the multi-task management interface into the main partition and the secondary partition for displaying different applications, a user may be able to use at least two applications at the same time, which may diversify means for displaying the application on the electronic device and may improve the user's experience as well.

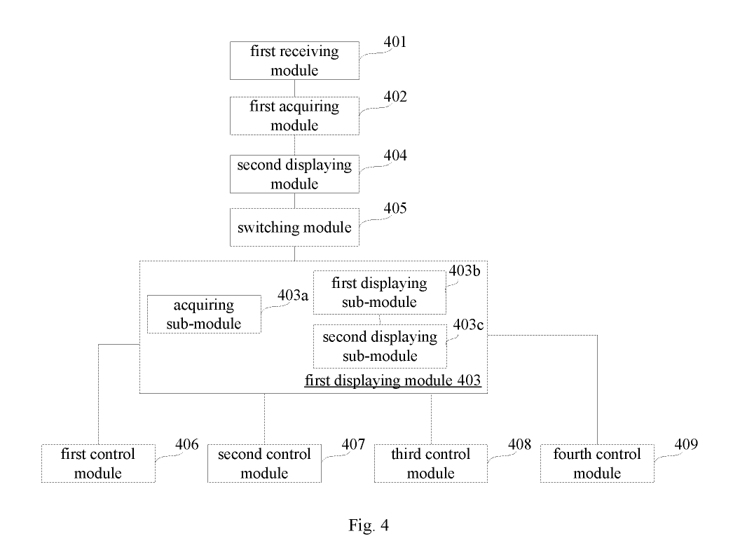

FIG. 4 is a block diagram illustrating a split-screen display apparatus according to another example embodiment of the present disclosure. The split-screen display apparatus is applied to an electronic device including a touch screen, which includes: a first receiving module 401, a first acquiring module 402 and a first displaying module 403.

The first receiving module 401 is configured to receive an operating signal for triggering display of a multi-task management interface. The multi-task management interface includes a main partition and secondary partition.

The operating signal described herein may be generated when a certain physical button on the electronic device is triggered, or may be a gesture input by the user on the touch screen of the electronic device, or may be generated when the electronic device is shaken following a preset track. The operating signal may be not limited in the embodiments of the present disclosure and may be determined depending on actual situations.

Generally, the multi-task management interface is configured to display applications running on the electronic device, and each of the applications displayed on the multi-task management interface may be displayed in a form of a previewing interface corresponding to the application. The previewing interface described herein may be a last interface of the application displayed on a screen of the electronic device before the application stops running in foreground. Alternatively, the previewing interface of the application may be a main interface corresponding to the application.

The first acquiring module 402 is configured to acquire a plurality of applications running on the electronic device. The plurality of applications include a first application and at least one second application.

The first displaying module 403 is configured to display the first application on the main and to display the at least one second application on the secondary partition.

Each of the plurality of applications may be displayed in the form of the previewing interface corresponding to the application when the applications running on the electronic device are displayed on the multi-task management interface.

Specifically, various arrangement modes may be adopted when previewing interfaces corresponding respectively to the applications are displayed. For example, the previewing interfaces corresponding respectively to the applications may be arranged horizontally in a single row according to a first preset order. For another example, the previewing interfaces corresponding respectively to the applications may be arranged horizontally in double rows according to the first preset order. The first preset order described herein may be an order of opening the applications recently, or may be an order of frequencies of using the applications, which may be determined depending on actual situations and may be not limited in the embodiments of the present disclosure.

It should be noted that the first application displayed on the main partition is running in foreground and may be operated by the user; the second application displayed on the secondary partition is also running in foreground and may also be operated by the user. In other words, the first application displayed on the main partition and the second application displayed on the secondary partition are both running in foreground and the user may operate any application displayed on any one of the main partition and the secondary partition. For example, the user may play games by using a game application displayed on the main partition and may chat with others by using a messaging application displayed on the secondary partition.

Alternatively, the first displaying module 403 includes: an acquiring sub-module 403a, a first displaying sub-module 403b, and a second displaying sub-module 403c.

The acquiring sub-module 403a is configured to acquire a last application running in foreground as the first application, and to display the first application on the main partition of the multi-task management interface.

The main partition may be set in any region of the multi-task management interface. Generally, the main partition may be set in a location of the multi-task management interface near a top of the screen.

The first displaying sub-module 403b is configured to display at least one previewing interface corresponding to at least one application other than a last application running in foreground on the secondary partition.

Various arrangement modes may be adopted when previewing interfaces corresponding respectively to the applications are displayed. For example, the previewing interfaces corresponding respectively to the applications may be arranged horizontally in a single row according to a second preset order. For another example, the previewing interfaces corresponding respectively to the applications may be arranged horizontally in double rows according to the second preset order. The second order described herein may be an order of opening the applications recently, or may be an order of frequencies of using the applications, which may be determined depending on actual situations and may be not limited in the embodiments of the present disclosure.

Generally, only a finite number of the previewing interfaces may be displayed on the secondary partition. The user may input a preset gesture to trigger more previewing interfaces corresponding respectively to the applications running on the electronic device to exhibit if the user wants to view more previewing interfaces corresponding respectively to the applications running on the electronic device in the secondary partition.

The second displaying sub-module 403c is configured to acquire a previewing interface selected from the at least one previewing interface displayed on the secondary partition, to configure an application corresponding to the selected previewing interface as one of the at least one second application, and to display the one of the at least one second application on the secondary partition of the multi-task management interface.

Alternatively, the split-screen display apparatus includes: a second acquiring module, a second receiving module, and an exhibiting module.

The second acquiring module is configured to acquire a third application selected from the secondary partition.

The second receiving module is configured to receive an exchange instruction for indicating to display the third application on the main partition.

Various means may be provided for the user to select the at least one application displayed on the secondary partition. For example, one of the at least one application may be selected as the third application by long pressing the previewing interface corresponding to the one of the at least one application, or by inputting a preset gesture on the previewing interface corresponding to the one of the at least one application. Generally, the exchange instruction described herein is the preset gesture the user inputs.

The exhibiting module is configured to move the third application to the main partition to exhibit and to move the first application to a location in the secondary partition where the third application is located for display.

Alternatively, the split-screen display apparatus includes: a second displaying module 404, and a switching module 405.

The second displaying module 404 is configured to display the applications running on the electronic device and a split-screen control on the multi-task management interface.

The split-screen control may be displayed on any location within the multi-task management interface. This embodiment takes a scenario in which the split-screen control is set at the top right corner of the multi-task management interface as an example for illustrating.

Generally, only a finite number of the previewing interfaces may be displayed on the screen of the electronic device. The user may input a preset gesture to trigger more previewing interfaces corresponding respectively to the applications running on the electronic device to exhibit if more previewing interfaces corresponding respectively to the applications running on the electronic device are needed to be viewed.

The switching module 405 is configured to switch from a displaying mode for the multi-task management interface to a split-screen mode if the split-screen control is triggered, in which the multi-task management interface in the split-screen mode includes the main partition and the secondary partition.

Generally, the applications running on the electronic device and the split-screen control are displayed on the multi-task management interface, and the displaying mode for the multi-task management interface may be switched to the split-screen mode if the split-screen control is triggered, and the multi-task management interface is split into the main partition and the secondary partition.

It should be noted that the multi-task management interface in the split-screen mode includes only one main partition, but may include one or more secondary partitions. This embodiment takes a scenario in which the multi-task management interface includes only one main partition and one secondary partition as an example for illustrating. Implementations of the scenario in which the multi-task management interface includes one main partition and several secondary partitions may be realized in accordance with means provided by this embodiment.

In some embodiments, the multi-task management interface in the split-screen mode is set with a segment control line which is movable and is configured to split the multi-task management interface into the main partition and the secondary partition.

In some embodiments, the main partition or the secondary partition includes a multifunctional virtual button for introducing to display at least one of a split-screen exit control, an exchange control and a group of switching controls, and the split-screen display apparatus further includes: a first control module 406, a second control module 407, a third control module 408, and a fourth control module 409.

The first control module 406 is configured to control the multi-task management interface to exit the split-screen mode if the split-screen exit control is triggered.

The multi-task management interface may be controlled to exit the split-screen mode if the split-screen exit control displayed is triggered. The multi-task management interface including the applications running on the electronic device and the split-screen control may be displayed normally and the first application displayed on the main partition may run (i.e., be displayed) in foreground after the multi-task management interface exits the split-screen mode, which may be not limited in this embodiment and may be determined depending on actual situations.

The second control module 407 is configured to control to exchange the application displayed on the main partition with the application displayed on the secondary partition if the exchange control is triggered.

The group of switching controls includes a first switching control for switching the application displayed on the main partition and a second switching control for switching the application displayed on the secondary partition.

The third control module 408 is configured to control the application running on the electronic device other than the first application to display on the main partition if the first switching control is triggered.

The fourth control module 409 is configured to control the application running on the electronic device other than the second application to display on the secondary partition if the second switching control is triggered.

It should be noted that this embodiment only takes a scenario that the multifunctional virtual button is provided on the secondary partition as an example. Implementation of a scenario that the multifunctional virtual button is provided on the main partition is similar to the implementation of a scenario that the multifunctional virtual button is provided on the secondary partition, which is not described herein.

In conclusion, according to the split-screen display apparatus provided by embodiments of the present disclosure, by receiving the operating signal for triggering the multi-task management interface to display, displaying the first application on the main partition of the multi-task management interface and displaying the at least one second application on the secondary partition of the multi-task management interface, in which the first application and the at least one second application are running on the electronic device, i.e., by splitting the multi-task management interface into the main partition and the secondary partition for displaying different applications, a user may be able to use at least two applications at the same time, which may diversify means for displaying the application on the electronic device and may improve the user's experience as well.

Additionally, by configuring the last application running in foreground as the first application in default and displaying the first application on the main partition, an operating procedure for acquiring the first application may be simplified and efficiency of split-screen display may be improved.

Additionally, the at least one previewing interface corresponding to at least one application other than a last application running in foreground may be displayed on the secondary partition for the user's selection, and the one of the at least one second application corresponding to the at least one previewing interface the user selects may be displayed on the secondary partition of the multi-task management interface.

Additionally, the multi-task management interface in the split-screen mode is set with a segment control line which is movable and is configured to split the multi-task management interface into the main partition and the secondary partition, such that the user may adjust sizes of the main partition and the secondary partition by moving the segment control line.

Additionally, by providing the split-screen exit control, the user may be able to control the multi-task management interface to exit the split-screen mode by triggering the split-screen exit control; and by providing the exchange control and the group of switching controls, the user may be able to switch the application displayed on the secondary partition and the application displayed on the main partition by using the exchange control and the group of switching controls.

Embodiments of the present disclosure provide a split-screen display device applied to an electronic device is provided, which includes: a processor; and a memory configured to store an instruction executable by the processor, in which the processor is configured to: receive an operating signal for triggering a multi-task management interface to display; acquire applications running on the electronic device; and display a first application on a main partition of the multi-task management interface and display at least one second application on a secondary partition of the multi-task management interface, in which the first application and the at least one second application are running on the electronic device.

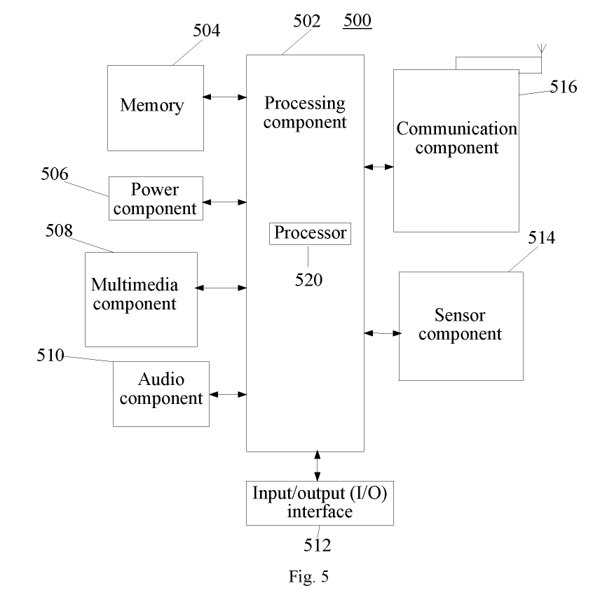

FIG. 5 is a block diagram illustrating a split-screen display device according to an example embodiment of the present disclosure. For example, the split-screen display device 500 may be a mobile phone, a computer, a digital broadcasting terminal, a message sending and receiving equipment, a game controller, a tablet device, a medical device, a fitness equipment, a personal digital assistant or the like.

Referring to FIG. 5, the split-screen display device 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the split-screen display device 500, such as the operations associated with display, telephone calls, data communications, camera operations, and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the split-screen display device 500. Examples of such data include instructions for any applications or methods operated on the split-screen display device 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the split-screen display device 500. The power component 506 may include a power management system, one or more power sources, and any other components associated with the generation, management, and distribution of power in the split-screen display device 500.

The multimedia component 508 includes a screen providing an output interface between the split-screen display device 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and the rear camera may receive an external multimedia datum while the split-screen display device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone (“MIC”) configured to receive an external audio signal when the split-screen display device 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the split-screen display device 500. For instance, the sensor component 514 may detect an open/closed status of the split-screen display device 500, relative positioning of components, e.g., the display and the keypad, of the split-screen display device 500, a change in position of the split-screen display device 500 or a component of the split-screen display device 500, a presence or absence of user contact with the split-screen display device 500, an orientation or an acceleration/deceleration of the split-screen display device 500, and a change in temperature of the split-screen display device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the split-screen display device 500 and other devices. The split-screen display device 500 can access a wireless network based on a communication standard, such as WiFi, 2G or 3G or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the split-screen display device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the split-screen display method described above.

In exemplary embodiments, there is also provided a non-transitory computer-readable storage medium including instructions, such as included in the memory 504, executable by the processor 520 in the split-screen display device 500, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium has stored therein instructions that, when executed by a processor of a split-screen display device 500, causes the split-screen display device 500 to perform methods illustrated in FIG. 1, FIG. 2A and FIG. 2G

Other embodiments of the present disclosure will be apparent to those skilled in the art from consideration of the specification and practice of the disclosure disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A split-screen display method applied to an electronic device, the method comprising:
receiving an operating signal for triggering display of a multi-task management interface, the multi-task management interface comprising a main partition and a secondary partition;
acquiring a plurality of applications running on the electronic device, the plurality of applications comprising a first application and at least one second application; and
displaying the first application on the main partition and displaying the at least one second application on the secondary partition.

2. The split-screen display method according to claim 1, wherein displaying the first application on the main partition comprises:
acquiring a last application running in foreground as the first application; and
displaying the first application on the main partition.

3. The split-screen display method according to claim 1, wherein displaying the at least one second application on the secondary partition comprises:
displaying, on the secondary partition, at least one previewing interface corresponding to at least one running application other than a last application running in foreground;
acquiring a previewing interface selected from the at least one previewing interface displayed on the secondary partition and configuring an application corresponding to the selected previewing interface as one of the at least one second application; and
displaying the one of the at least one second application on the secondary partition.

4. The split-screen display method according to claim 3, wherein the at least one previewing interface displayed on the secondary partition comprises a plurality of previewing interfaces arranged horizontally in a single row according to a first preset order.

5. The split-screen display method according to claim 4, wherein the first preset order is an order of opening applications corresponding to the plurality of previewing interfaces recently.

6. The split-screen display method according to claim 4, wherein the first preset order is an order of frequencies of using applications corresponding to the plurality of previewing interfaces.

7. The split-screen display method according to claim 1, further comprising:
acquiring a third application selected from the secondary partition;
receiving an exchange instruction for indicating to display the third application on the main partition; and
moving the third application to the main partition for display and moving the first application to a location in the secondary partition where the third application is located for display.

8. The split-screen display method according to claim 1, further comprising:
displaying, on the multi-task management interface, the plurality of applications running on the electronic device and a split-screen control; and
switching from a displaying mode for the multi-task management interface to a split-screen mode if the split-screen control is triggered, wherein the multi-task management interface in the split-screen mode comprises the main partition and the secondary partition.

9. The split-screen display method according to claim 1, wherein the multi-task management interface in the split-screen mode comprises a movable segment control line for splitting the multi-task management interface into the main partition and the secondary partition.

10. The split-screen display method according to claim 1, wherein the main partition or the secondary partition comprises a multifunctional virtual button for introducing to display at least one of:
a split-screen exit control for controlling the multi-task management interface to exit the split-screen mode;
an exchange control for controlling to exchange the application displayed on the main partition with the application displayed on the secondary partition; and
a group of switching controls comprising:
a first switching control for switching the application displayed on the main partition; and
a second switching control for switching the application displayed on the secondary partition.

11. A split-screen display apparatus applied to an electronic device, the apparatus comprising:
a processor; and
a memory configured to store an instruction executable by the processor;
wherein the processor is configured to:
receive an operating signal for triggering display of a multi-task management interface, the multi-task management interface comprising a main partition and a secondary partition;
acquire a plurality of applications running on the electronic device, the plurality of applications comprising a first application and at least one second application; and
display the first application on the main partition and displaying the at least one second application on the secondary partition.

12. The split-screen display apparatus according to claim 11, wherein the processor configured to display the first application on the main partition is further configured to:
acquire a last application running in foreground as the first application; and
display the first application on the main partition.

13. The split-screen display apparatus according to claim 11, wherein the processor configured to display the at least one second application on the secondary partition is further configured to:
display, on the secondary partition, at least one previewing interface corresponding to at least one running application other than a last application running in foreground; and
acquire a previewing interface selected from the at least one previewing interface displayed on the secondary partition and configure an application corresponding to the selected previewing interface as one of the at least one second application; and
display the one of the at least one second application on the secondary partition.

14. The split-screen display apparatus according to claim 13, wherein the at least one previewing interface displayed on the secondary partition comprises a plurality of previewing interfaces arranged horizontally in a single row according to a first preset order.

15. The split-screen display apparatus according to claim 14, wherein the first preset order is an order of opening applications corresponding to the plurality of previewing interfaces recently.

16. The split-screen display apparatus according to claim 11, wherein the processor is further configured to:
acquire a third application selected from the secondary partition;
receive an exchange instruction for indicating to display the third application on the main partition; and
move the third application to the main partition for display and move the first application to a location in the secondary partition where the third application is located for display.

17. The split-screen display apparatus according to claim 11, wherein the processor is further configured to:
display, on the multi-task management interface, the plurality of applications running on the electronic device and a split-screen control; and
switch from a displaying mode for the multi-task management interface to a split-screen mode if the split-screen control is triggered, wherein the multi-task management interface in the split-screen mode comprises the main partition and the secondary partition.

18. The split-screen display apparatus according to claim 11, wherein the multi-task management interface in the split-screen mode comprises a movable segment control line for splitting the multi-task management interface into the main partition and the secondary partition.

19. The split-screen display apparatus according to claim 11, wherein the main partition or the secondary partition comprises:
a split-screen exit control for controlling the multi-task management interface to exit the split-screen mode;
an exchange control for controlling to exchange the application displayed on the main partition with the application displayed on the secondary partition; and
a group of switching controls comprising:
a first switching control for switching the application displayed on the main partition; and
a second switching control for switching the application displayed on the secondary partition.

20. A non-transitory computer readable storage medium having stored therein instructions that, when executed by a processor, causes the processor to perform a split-screen display method, the method comprising:
receiving an operating signal for triggering display of a multi-task management interface, the multi-task management interface comprising a main partition and a secondary partition;
acquiring a plurality of applications running on the electronic device, the plurality of applications comprising a first application and at least one second application; and
displaying the first application on the main partition and displaying the at least one second application on the secondary partition.
